(19) United States
(12) Patent Application Publication
(10) Pub. No.: US 2014/0172377 A1
(43) Pub. Date: Jun. 19, 2014

(54) METHOD TO RECONSTRUCT A SURFACE FROM ORIENTED 3-D POINTS

(71) Applicant: Brown University, Providence, RI (US)

(72) Inventors: Gabriel Taubin, Providence, RI (US); Fatih Calakli, Providence, RI (US)

(73) Assignee: Brown University, Providence, RI (US)

(21) Appl. No.: 14/032,379

(22) Filed: Sep. 20, 2013

Related U.S. Application Data
(60) Provisional application No. 61/703,541, filed on Sep. 20, 2012.

(51) Int. Cl. G06F 17/50

(52) U.S. Cl. CPC G06F 17/5018
USPC 703/1

(57) ABSTRACT

A method for the problem of reconstructing a watertight surface defined by an implicit equation from a finite set of oriented points. As in other surface reconstruction approaches disctretizations of this continuous formulation reduce to the solution of sparse least-squares problems. Rather than forcing the implicit function to approximate the indicator function of the volume bounded by the surface, in the present formulation the implicit function is a smooth approximation of the signed distance function to the surface. Then solution thus introduced is a very simple hybrid FE/FD discretization, which together with an octree partitioning of space, and the Dual Marching Cubes algorithm produces accurate and adaptive meshes.

### CROSS-REFERENCE TO RELATED APPLICATIONS

This application is related to and claims priority from earlier filed U.S. Provisional Patent Application No. 61/703,541, filed Sep. 20, 2012.

### GOVERNMENT FUNDING

The subject matter of this application was funded in part by NSF Grants CCF-0729126, IIS-0808718, CCF-0915661, and IIP-1215308.

### BACKGROUND OF THE INVENTION

The present invention relates to the problem of reconstructing a geometry and a topology of an implicit surface, also referred to in the prior art as a watertight surface, from a finite set of oriented points. Each oriented point comprising a point location and a point orientation vector, the point location being a three dimensional point, the point orientation vector being a three dimensional vector. The present invention also relates to the problem of reconstructing the geometry, the topology, and a color appearance of the watertight surface from a finite set of colored oriented points. Each colored oriented point being an oriented point and further comprising a point color, the point color being an RGB three dimensional value, the appearance being a surface color map. Furthermore, the present invention also relates to the problem of reconstructing the geometry, the topology, and the color appearance of a watertight surface from a finite set of photographs of a three dimensional object. The invention is particularly related to the problem of reconstructing colored surfaces from multi-view image and video data captured using consumer level digital and video cameras.

These surface reconstruction problems have applications in a wide range of fields, such as: entertainment, virtual reality, cultural heritage, archeology, forensics, the arts, medical imaging, 3D printing, industrial design, industrial inspection and many other areas. Oriented point clouds and colored oriented point clouds are also referred to in the prior art as oriented point clouds. Oriented point clouds are presently obtained using various optical measuring devices, such as laser scanners and inexpensive structured lighting systems, by other computational means such as multi-view stereo reconstruction algorithms, and also result from large scale simulations. Since digital still and video cameras are very low cost nowadays and are in widespread use, the reconstruction of surfaces from multiple photographs and video streams is of particular interest. The problems are particularly challenging due to the non-uniform sampling nature of the data collection processes. FIG. 14 illustrates the ideal case of uniformly sampled dat 1400; common problems to cope with including: non-uniform sampled data 1410 due to concave surfaces, missing data due to inaccessible regions, noisy data 140 due to sensor characteristics, and distorted data due to misalignment of partial scans 1430; and an oriented point cloud with all of these problems.

Two mathematical representations of surfaces are described in the prior art: parametric surfaces and implicit surfaces. This invention reconstructs surfaces represented as implicit surfaces. The set of oriented points, also referred to in the prior art as point cloud, has become a popular computer representation for surfaces resulting from sampling processes. The point location of an oriented point is regarded as a sample of the underlying surface. The point orientation vector of an oriented point is regarded as a sample of the surface normal vector field at the point location. Several existing 3D scanning methods produce oriented points with associated colors. In the computer representation of a surface as a set of oriented points or as a set of colored oriented points, the point locations are disjointed relative to one another. A popular and simple data structure used to represent point clouds in a computer memory is based on arrays. A coordinates array is used to store the point locations, a normal vector array is used to store the point orientation vectors, and an optional color array is used to store the point colors. This data structure does not provide explicit neighborhood information. For some applications this lack of explicit neighborhood information is not a problem. For example, if the point cloud constitutes a dense sampling of the underlying continuous surface, and each oriented point is simply rendered as a disk that is large enough to overlap the adjacent points, the resulting image produced by this point splatting rendering scheme provides the appearance of a continuous surface. However, since the disks are smaller, the rendering of the surface does not appear to be a continuous surface. This representation is sufficient and appropriate for many applications, but other applications require explicit neighborhood information. Another popular computer representation of a surface with has neighborhood information is the polygon mesh.

Recent advances in three-dimensional (3D) data-acquisition hardware and software have facilitated the increasing use of 3D scanning techniques to document the geometry and appearance of physical objects. For example, an object may be 3D scanned for archival purposes or as a step in the design of new products. Recently, there has been a proliferation of 3D scanning equipment and algorithms for generating computer representations of surfaces from scanned data. Laser 3D scanning systems, for example, can generate highly accurate surface measurements organized as regular 2D arrays of oriented points or of colored oriented points. The difficulty, however, is that laser 3D scanning systems are expensive and do not capture all the points at the same time. As a result, laser 3D scanning systems are primarily used in industrial applications and when the surfaces being scanned are static. Other methods to capture oriented points from photographs are stereo and multi-view stereo algorithms.

An ideal acquisition system returns samples lying exactly on the object surface. Any real measurement system, however, introduces some error resulting in samples which only approximate the location of points on the object surface. Nonetheless, if a system returns samples with an error that is orders of magnitude smaller than the minimum feature size, the sampling can generally be regarded as “perfect.” A surface can then be reconstructed by finding an interpolating mesh without additional operations on the measured data. Most scanning systems still need to account for acquisition error. There are two sources of error: error in registration and error along the sensor line of sight. Most surface reconstruction methods produce computer representations of surfaces which approximate the underlying continuous surface. Of particular concern is the development of methods and systems robust with respect to the issues mentioned above, and able to scale up to very large data sets in common use nowadays.

The prior art in surface reconstruction methods is extensive but no prior art method satisfy all these requirements. Generally the prior art methods reduce the surface reconstruction problem to the solution of a large scale numerical optimization problem, and use schemes based on space partition data structures such as octrees to reduce the computational and storage complexity. All these methods are complex and not necessarily scalable.

A need therefore exists for a method that captures a 3-D cloud of oriented points from a plurality of photographic images and then generates a watertight surface based on the cloud of oriented points. A further need exists for a method that creates a watertight surface reconstruction form unorganized set of points that exhibits hag quality and accuracy and does not suffer from over smoothing.

### BRIEF SUMMARY OF THE INVENTION

In this regard, the present invention provides generally for the reconstructing a watertight surface from a finite set of oriented points. The watertight surface is defined as the set of zeros of an implicit function, which is forced to be a smooth approximation of the signed distance function to the surface. This smooth signed distance function is determined from the set of oriented points as the solution of a minimization problem. The formulation allows for a number of different efficient discretizations, reduces to a finite least squares problem for all linearly parameterized families of functions, and does not require boundary conditions. The smooth signed distance has approximate unit slope in the neighborhood of the data points. As a result, the normal vector data can be incorporated directly into the energy function without implicit function smoothing, along with a regularization term, and a single variational problem is solved directly in one step. The resulting algorithms are significantly simpler and easier to implement, and produce results of better quality than state-of-the-art algorithms.

A preferred embodiment of the present invention provides for the reconstructing a watertight colored surface from a finite set of color oriented points, by solving a second variational problem to reconstruct a surface color map.

Another preferred embodiment of the present invention automates the process of building a watertight colored surface from multiple photographs of an object. The 3D model has sufficient detail as compared to the original object that it then allows for comparison to structured libraries containing known shapes, records, characters and languages allowing accurate transcription, translation or shape matching. A more preferred embodiment of the invention then takes the data embedded in those models to extract dimensionable objects such as for example character sets that can be compared against a known corpus of signs in order to extract linguistic meaning.

It is therefore a first object of the present invention to provide a method and system for reconstructing a watertight surface from a set of oriented points. It is a second object of the present invention to provide a method and system for reconstructing a watertight colored surface from a set of colored oriented points. It is a third object of the present invention to provide a method and system for reconstructing a watertight colored surface from a set of photographs of a three dimensional object. It is a further object of the present invention to provide a method and system that generates an accurate surface representation that can be employed for feature matching relative to a database of known surfaces.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which preferred embodiments of the invention are illustrated.

### BRIEF DESCRIPTION OF THE DRAWINGS

In the drawings which illustrate the best mode presently contemplated for carrying out the present invention:

FIG. 1 is shows a finite set of oriented point points;

FIG. 2 shows a method for reconstructing a surface from a finite set of oriented points;

FIG. 3 shows a method for 3D scanning a 3D object;

FIG. 4 shows the point locations of a set of oriented points contained within a signed distance domain;

FIG. 5 shows a smooth signed distance function defining an implicit surface generated by a method to reconstruct an implicit surface from a set of oriented points contained in a smooth signed distance domain;

FIG. 6 shows a colored oriented point cloud, a surface reconstructed using only the point locations and point orientation vectors, and a colored surface reconstructed using the point locations, the point orientation vectors, and the point colors;

FIG. 7 an hexahedral cell;

FIG. 8 shows an oriented point cloud contained within a smooth signed distance domain partitioned into a voxel grid;

FIG. 9 shows an oriented point cloud contained within a smooth signed distance domain partitioned into an octree;

FIG. 10 shows a colored point cloud obtained from a set of photographs, the surface reconstructed from the oriented points, and the colored surface reconstructed from the colored oriented points;

FIG. 11 shows an application of the present invention to a problem of interest such as the reconstruction of cuneiform tablet surfaces;

FIG. 12 depicts the present invention in a urban scene reconstruction application;

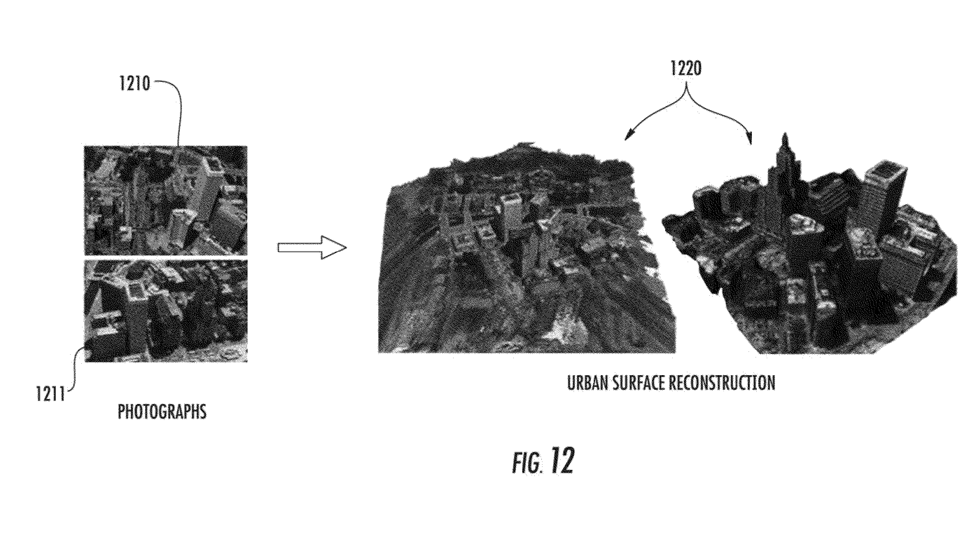

FIG. 13 depicts the present invention in a forensic application;

FIG. 14 illustrates the ideal case of uniformly sampled data; common problems to cope with including: non-uniform sampled data due to concave surfaces, missing data due to inaccessible regions, noisy data due to sensor characteristics, and distorted data due to misalignment of partial scans; and an oriented point cloud with all of these problems; and

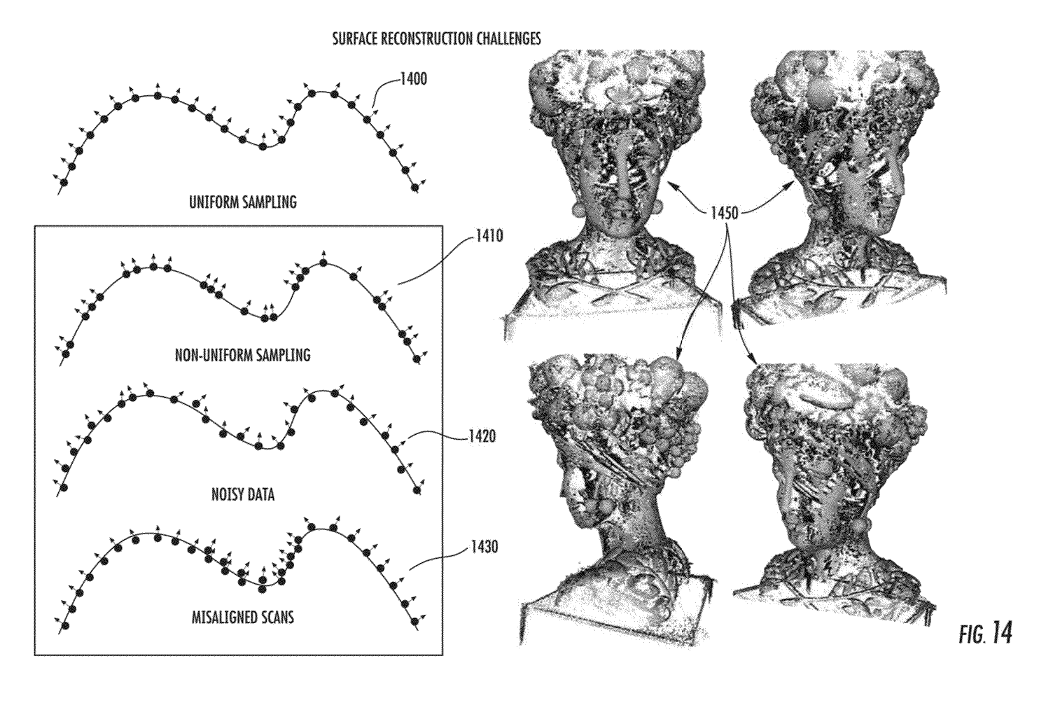

FIGS. 15-16 shows a surface containing spurious components located far away from the data points.

### DETAILED DESCRIPTION OF THE INVENTION

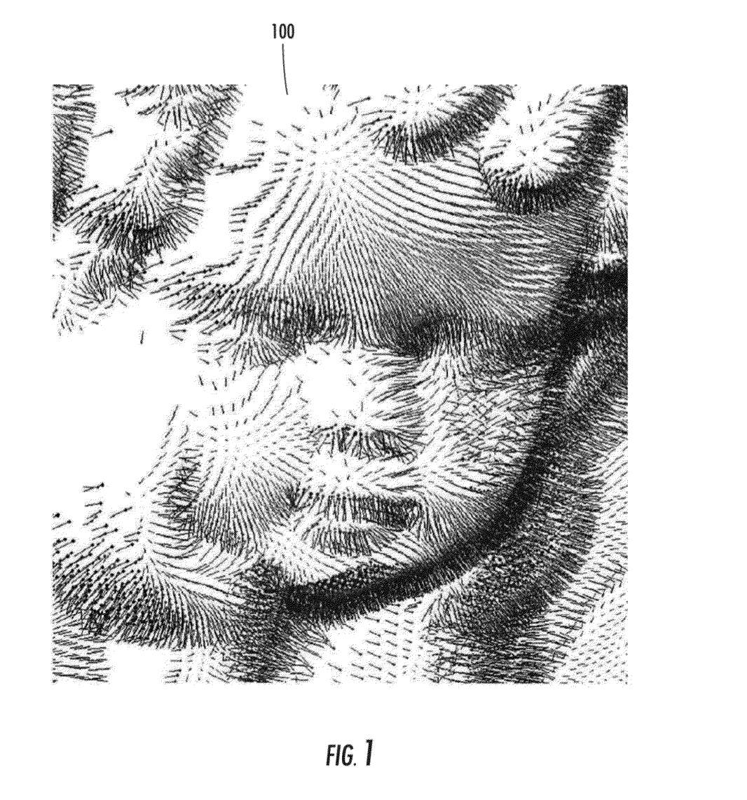

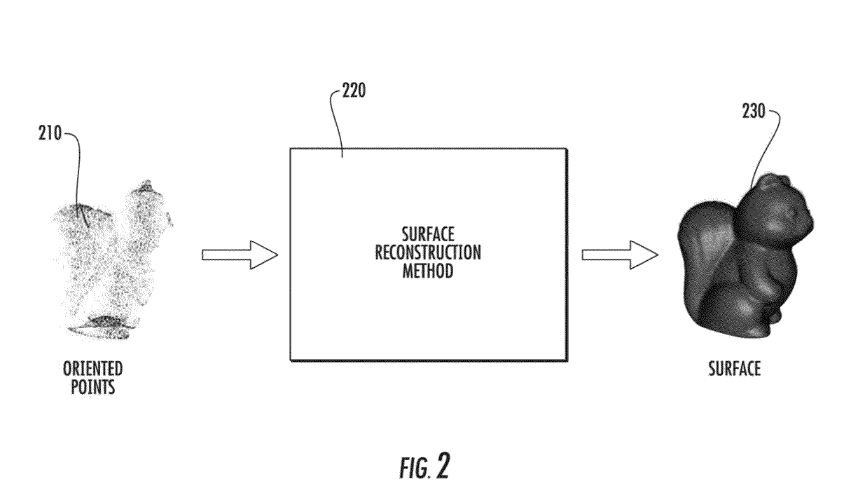

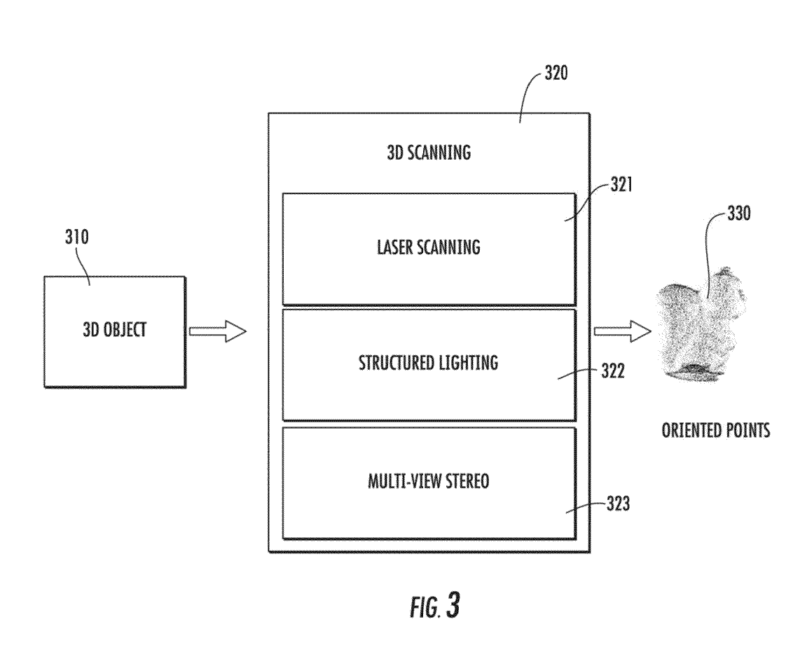

The present invention provides generally for a method for reconstructing a surface from a finite set of oriented points. FIG. 1 shows a finite set of oriented points 100. FIG. 2 shows a method 220 for reconstructing a surface 230 from a finite set of oriented points 210. An oriented point (p,n) comprises a point location p and a point orientation vector n. FIG. 3 shows a method 320 for 3D scanning a 3D object 310. A set of oriented points 320 is obtained using 3D scanning methods and systems 320 known and described in the art such as laser scanning systems 321, structured lighting systems 322, and multi-view stereo methods 322, as samples of the boundary surface of a 3D object 310. Sets of oriented points are also generated by other methods, such as interactive geometric modeling systems, and large-scale computer simulations.

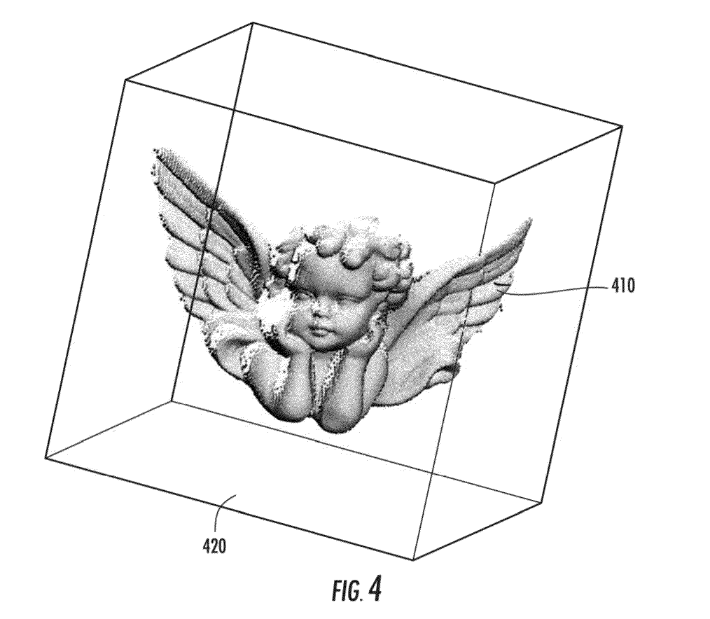

We begin with the assumption that a set of oriented points P={(p₁, n₁), . . . , (p_{N}, n_{N})} has already been acquired by 3D scanning the surface of a 3D object, or generated by another method, and that all the point locations are contained in a signed distance domain D. FIG. 4 shows the point locations 410 of a set of oriented points contained within a signed distance domain 420. The method applies to regularly sampled points as well as unevenly sampled points, and it is not required that the set of oriented points be a uniform sampling of the surface. The method comprises two steps: the first step of minimizing an energy functional comprising a weighted sum of a first data term, a second data term, and a third regularization term:

$$E ( f ) = {λ}_{0} {\sum }_{i = 1}^{N} {f ( {p}_{i} )}^{2} + {λ}_{1} {\sum }_{i = 1}^{N} {‖ ▽ f ( {p}_{i} ) - {n}_{i} ‖}^{2} + {λ}_{2} {\int }_{D}^{ } {‖ Hf ( x ) ‖}^{2} d x$$

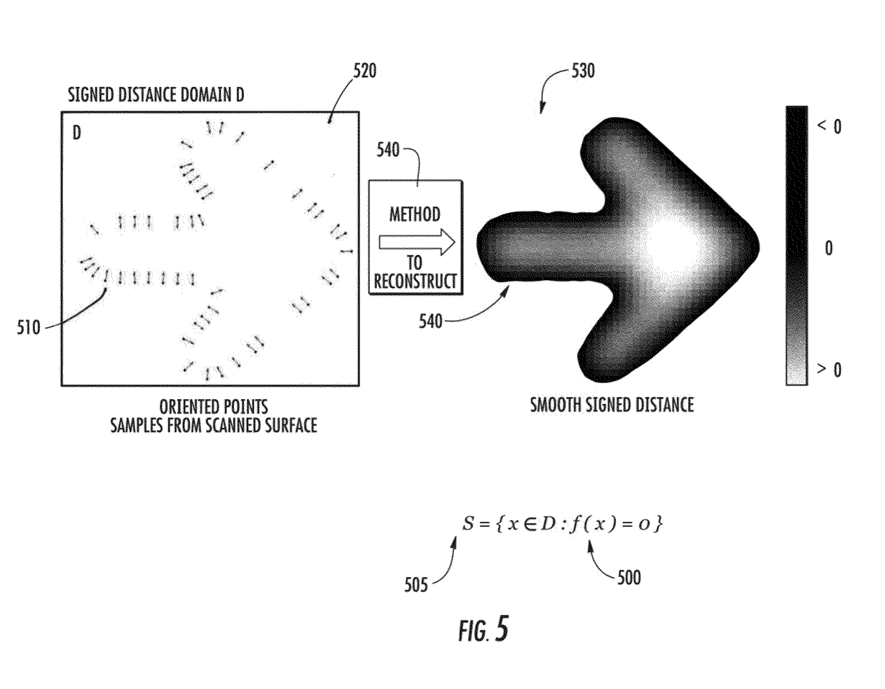

resulting in a signed distance function ƒ(x) defined on the signed distance domain D, the signed distance function attaining positive and negative values; and the second step of generating the surface as the set of level zero of the signed distance function S=(xεD:ƒ(x)=0}. The parameters λ₀, λ₁, and λ₂ are positive numbers also provided to the method as input along with the set of oriented points. FIG. 5 shows a smooth signed distance function 500 defining an implicit surface 505 generated by a method 540 to reconstruct an implicit surface 505,540 from a set of oriented points 510 contained in a smooth signed distance domain 520.

In a preferred embodiment the shape and dimensions of the signed distance domain is determined by enclosing the point locations in a three dimensional bounding box, and optionally expanding the bounding box dimensions by certain amount to prevent boundary-related artifacts in the minimization of the energy functional.

The signed distance function ƒ(x) is restricted to those belonging to a family of feasible signed distance functions Ω. In a preferred embodiment of the method, the feasible signed distance functions have continuous partial derivatives up to second order. In another preferred embodiment the feasible signed distance functions are generalized functions. In another preferred embodiment the feasible signed distance functions are piecewise smooth continuous functions with discontinuous first order partial derivatives and generalized functions as second order partial derivatives. In another preferred embodiment the feasible signed distance functions are parameterized by a finite number of parameters. In a more preferred embodiment feasible signed distance functions ƒ(x) are linearly parameterized by a finite number of parameters η_{α} as a finite linear combination of basis functions

$$f ( x ) = {\sum }_{α ∈ Λ}^{ } {η}_{α} {f}_{α} ( x )$$

the basis functions ƒ_{α}(x) being independent of the oriented points. The functional E(ƒ) is the weighted sum of three terms; a first data term

$${\sum }_{i = 1}^{N} {f ( {p}_{i} )}^{2} ;$$

a second data term

$${\sum }_{i = 1}^{N} {‖ ∇ f ( {p}_{i} ) - {n}_{i} ‖}^{2} ;$$

and a third regularization term ∫_{D}∥Hƒ(x)∥² dx, where

$$∇ f ( x ) = [ \begin{matrix}\begin{matrix}\frac{\partial f ( x )}{\partial {x}_{1}} \\ \frac{\partial f ( x )}{\partial {x}_{2}}\end{matrix} \\ \frac{\partial f ( x )}{\partial {x}_{3}}\end{matrix} ]$$

denotes the gradient of the function ƒ(x), and

$$Hf ( x ) = [ \begin{matrix}\frac{\partial ∇ f ( x )}{\partial {x}_{1}} & \frac{\partial ∇ f ( x )}{\partial {x}_{2}} & \frac{\partial ∇ f ( x )}{\partial {x}_{3}}\end{matrix} ] = [ \begin{matrix}\frac{{\partial }^{2} f ( x )}{\partial {x}_{1}^{2}} & \frac{{\partial }^{2} f ( x )}{\partial {x}_{1} \partial {x}_{2}} & \frac{{\partial }^{2} f ( x )}{\partial {x}_{1} \partial {x}_{3}} \\ \frac{{\partial }^{2} f ( x )}{\partial {x}_{1} {x}_{2}} & \frac{{\partial }^{2} f ( x )}{\partial {x}_{2}^{2}} & \frac{{\partial }^{2} f ( x )}{\partial {x}_{2} \partial {x}_{3}} \\ \frac{{\partial }^{2} f ( x )}{\partial {x}_{1} \partial {x}_{3}} & \frac{{\partial }^{2} f ( x )}{\partial {x}_{2} \partial {x}_{3}} & \frac{{\partial }^{2} f ( x )}{\partial {x}_{3}^{2}}\end{matrix} ]$$

denotes the Hessian of the function ƒ(x). The first data term is equal to the sum of the squares of the values that the signed distance function attains when evaluated on the point locations. The second data term is equal to the sum of the squares of the Euclidean norms of the differences between the values that the gradient of the signed distance function attains when evaluated on a point location, minus the corresponding point orientation vector. The regularization term is the integral of the square of the Frobenius norm of the Hessian of the signed distance function over the signed distance domain. If the family of feasible signed distance functions is composed of generalized functions, the partial derivatives as well as the integral have to be interpreted in the sense of generalized functions.

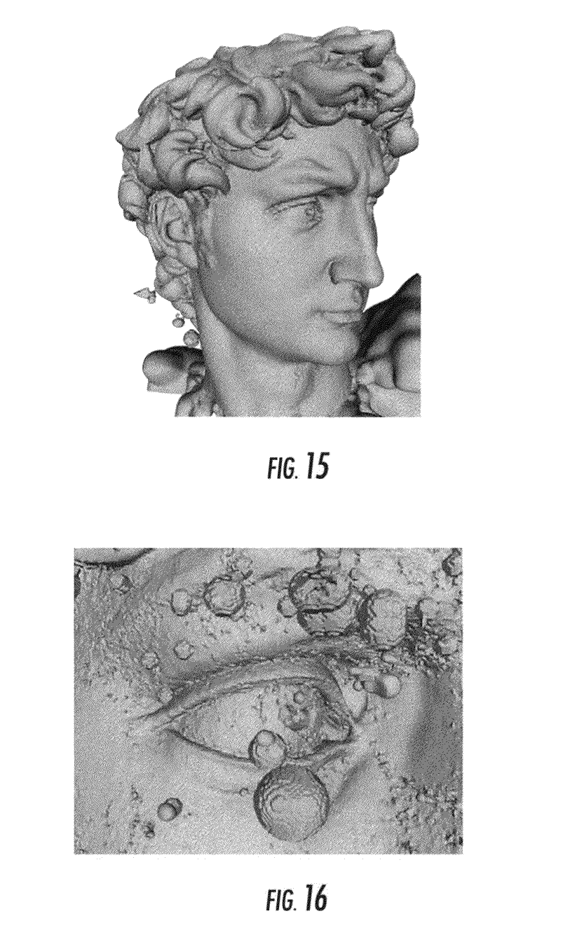

The gradient ∇ƒ(x) of a signed distance function ƒ(x) with first order continuous derivatives is a vector field normal to the level sets of the signed distance function, and in particular to the surface S. It is well established in the mathematical literature that under these conditions, if the gradient ∇ƒ(x) does not vanish on the surface S, then S is a manifold surface with no singular points. Without loss of generality, we will further assume that the gradient field on the surface S is of unit length ∥∇ƒ(x)∥=1, which allows us to directly compare the gradient of the function evaluated at the point locations with the corresponding point orientation vectors. Since the points pᵢ are regarded as samples of the surface S, and the normal vectors nᵢ as samples of the surface normal vector field at the corresponding points, for an interpolatory scheme the implicit function should satisfy ƒ(pᵢ)=0 and ∇ƒ(pᵢ)=nᵢ for all the points i=1, . . . , N in the set of oriented points. Interpolating schemes, which require parameterized families of functions with very large numbers of degrees of freedom, are not desirable in the presence of measurement noise. For an approximating scheme, which is what we are after, we require that these two interpolating conditions be satisfied in the least squares sense. The first data term and the second data term incorporate these soft constraints into the energy function E(ƒ). But these two data terms do not specify how the function should behave away from the data points. Many parameterized families of feasible signed distance functions have parameters highly localized in space, and the energy function of equation (1) may not constrain all the parameters. If the unconstrained parameters are arbitrarily set to zero, the estimated surface S may end up containing spurious components located far away from the data points, as we can observe in FIGS. 15 and 16. The regularization term addresses this problem. As a result, we consider the problem formulated as the minimization of the functional E(ƒ).

The approach described above can be extended to the case of basis functions with derivatives continuous only up to first order, and with second order derivatives which are integrable in the signed distance domain D in the sense of generalized functions. As long as the signed distance function ƒ(x), the gradient ∇ƒ(x), and the Hessian Hƒ(x) can be written as homogeneous linear functions of the same parameters η_{α}, the problem still reduces to the solution of a system of linear equations. In fact, even independent discretizations for the signed distance function ƒ(x), the gradient ∇ƒ(x) and the Hessian Hƒ(x) can be used, again, as long as all these expressions are homogeneous linear functions of the same parameters.

In a preferred embodiment the first step of the method consists in minimizing an extended energy functional comprising an extended weighted sum of the first data term

$${\sum }_{i = 1}^{N} {f ( {p}_{i} )}^{2} ,$$

a second extended data term

$${\sum }_{i = 1}^{N} {‖ v ( {p}_{i} ) - {n}_{i} ‖}^{2} ,$$

and a third extended regularization term ∫_{V}∥M(x)∥²dx

$$E ( f , v , M ) = {λ}_{0} {\sum }_{i = 1}^{N} {f ( {p}_{i} )}^{2} + {λ}_{1} {\sum }_{i = 1}^{N} {‖ v ( {p}_{i} ) - {n}_{i} ‖}^{2} + {λ}_{2} {\int }_{V}^{ } {‖ M ( x ) ‖}^{2} d x$$

where the parameters λ₀, λ₁, and λ₂ are positive numbers also provided to the method as input along with the set of oriented points. The second extended data term is equal to the sum of the squares of the Euclidean norms of the differences between the values a vector field evaluated on a point location ν(pᵢ), minus the corresponding point orientation vector nᵢ. The extended regularization term is the integral of the square of the Frobenius norm of a symmetric matrix field M(x) over the signed distance domain. The vector field is restricted to those belonging to a family of feasible vector fields, and the matrix field is restricted to those belonging to a family of matrix fields. The extended energy functional attains the same values as the energy functional when the vector field is equal to the gradient of the signed distance function and the matrix field is equal to the Hessian of the signed distance function. In a preferred embodiment the vector field is an approximation to the gradient of the signed distance function and the matrix field is an approximation to the Hessian of the signed distance function. In another preferred embodiment the feasible signed distance functions are parameterized by a finite number of common parameters, the feasible vector fields are parameterized by the same finite number of common parameters, and the feasible matrix fields are parameterized by the same finite number of common parameters.

In a more preferred embodiment the feasible signed distance functions are linearly parameterized by the finite number of common parameters η_{α} as a linear combination of function basis functions

$$f ( x ) = {\sum }_{α ∈ Λ}^{ } {η}_{α} {f}_{α} ( x ) ,$$

the function basis function being independent of the oriented points; the feasible vector fields are linearly parameterized by the finite number of common parameters as a linear combination of vector basis functions

$$v ( x ) = {\sum }_{α ∈ Λ}^{ } {η}_{α} {v}_{α} ( x ) ,$$

the vector basis function being independent of the oriented points; and the feasible matrix fields are linearly parameterized by the finite number of common parameters as a linear combination of matrix basis functions

$$M ( x ) = {\sum }_{α ∈ Λ}^{ } {η}_{α} {M}_{α} ( x ) ,$$

the matrix basis function being independent of the oriented points. In an even more preferred embodiment, the function basis functions are continuous functions, the vector basis functions are piecewise continuous, and the matrix basis functions are generalized functions. In this preferred embodiment the generalized energy functional E(ƒ, ν, M) reduces to a quadratic function Q(F)=F′AF−2B″F+C of the common parameters η_{α} organized as a column vector F. In the non-negative quadratic function the quadratic terms are defined by a non-negative definite symmetric matrix A, the linear terms by a column vector B, and the constant term by the scalar value C. Minimizing the quadratic function Q(F) is equivalent to solving the linear system of equations AF=B defined by the non-negative definite symmetric matrix A and the column vector B. The component elements of the non-negative definite symmetric matrix A and the column vector B are obtained by replacing the linear combinations in the generalized energy function

$$Q ( F ) = E ( {\sum }_{α ∈ Λ}^{ } {η}_{α} {f}_{α} ( x ) , {\sum }_{α ∈ Λ}^{ } {η}_{α} {v}_{α} ( x ) , {\sum }_{α ∈ Λ}^{ } {η}_{α} {M}_{α} ( x ) )$$

and expanding the resulting expression using algebraic operations. Note that the first data term, the second generalized data term, and the third generalized regularization term all contribute to the non-negative symmetric matrix A, but only the second generalized data term contributes to the column vector B. The components of the column vector B are computed using the following expression

$${B}_{α} = {λ}_{1} {\sum }_{i = 1}^{N} {n}_{i}^{t} {v}_{α} ( {p}_{i} )$$

The non-negative symmetric matrix A can be decomposed as the sum of three matrices

A=A₀+A₁+A₂;

a first matrix A₀ containing the contributions of the first data term, a second matrix A₁ containing the contributions of the second generalized data term, and a third matrix A₂ containing the contributions of the third generalized regularization term. The first matrix has the following expression

$${A}_{0 , α β} = {λ}_{0} {\sum }_{i = 1}^{N} {f}_{α} ( {p}_{i} ) {f}_{β} ( {p}_{i} ) ;$$

the second matrix has the following expression

$${A}_{1 , α β} = {λ}_{1} {\sum }_{i = 1}^{N} {v}_{α}^{t} {v}_{β} ( {p}_{i} ) ;$$

and the third matrix has the following expression

A_{2,αβ}=λ₂∫_{V} [symbol] M_{α}(x),M_{β}(x) [symbol] dx.

In this last expression the integrand is the Frobenius inner product of the matrices M_{α}(x) and M_{β}(x). In general, if M and N are two matrices of identical dimensions, the Frobenius inner product of M and N is defined in the prior art by the following expression

[symbol]

M,N [symbol] =Σ_{i,j}MᵢⱼNᵢⱼ.

In particular, when the matrix M_{α}(x) is equal to the Hessian Hƒ_{α}(x) of the signed distance function ƒ_{α}(x) and the matrix M_{β}(x) is equal to the Hessian Hƒ_{β}(x) of the signed distance function ƒ_{β}(x), the previous expression becomes

$$〈 {Hf}_{α} ( x ) , {Hf}_{β} ( x ) 〉 = {\sum }_{i = 1}^{3} {\sum }_{j = 1}^{3} \frac{{\partial }^{2} {f}_{α} ( x )}{\partial {x}_{i} \partial {x}_{j}} \frac{{\partial }^{2} {f}_{β} ( x )}{\partial {x}_{i} \partial {x}_{j}} .$$

If the number of common parameters η_{α} is small, as in the case of polynomial basis functions, solving the linear system AF=B is straightforward. One of many direct linear solvers for matrices represented as arrays can be used, including the QR method. However, in most surface reconstruction problems, a large number of degrees of freedom, typically O(N), is required for acceptable quality results, where N is the number of oriented points. For example, radial basis functions are non-zero almost everywhere, and result in a dense matrix A. This is not only a problem in terms of storage, but also in terms of speed, since out-of-core storage of matrix and vector may be required along with simple and slow iterative schemes. On the other hand, the matrix A is sparse when the basis functions are compactly supported, so that the support of only a small number of basis functions overlaps at any given point in the domain D. This property also results in many of the integrals ∫_{V} [symbol] M_{α}(x),M_{β}(x) [symbol] dx defining the components A_{2,αβ} of the third matrix being zero: if the supports of M_{α}(x) and M_{β}(x) do not intersect, then the third matrix component A_{2,αβ} is equal to zero.

Usually we are only interested in reconstructing the watertight surfaces within a bounded smooth signed distance domain, such as a cube containing all the point locations, which may result in an open surface at the boundaries of the smooth signed distance domain, particularly when the points only sample one side of the object, there are holes in the data, or more generally if the points are not uniformly distributed along the surface of the solid object. Point clouds produced by 3D scanning systems are viewpoint dependent, and to cover the whole surface of the object several scans need to be registered and merged. The algorithm is applied to point clouds retrieved either from a single partial 3D scan, or from multiple 3D scans that have been aligned with respect to a common reference frame. All 3D scanners measure point locations, and some also measure point colors. Very few 3D scanners provide independent measurements of point normal vectors. In the absence of this information, the direction of the point normal vectors are estimated from partially triangulated scans, and their orientations are determined from the viewpoint direction to the scanner.

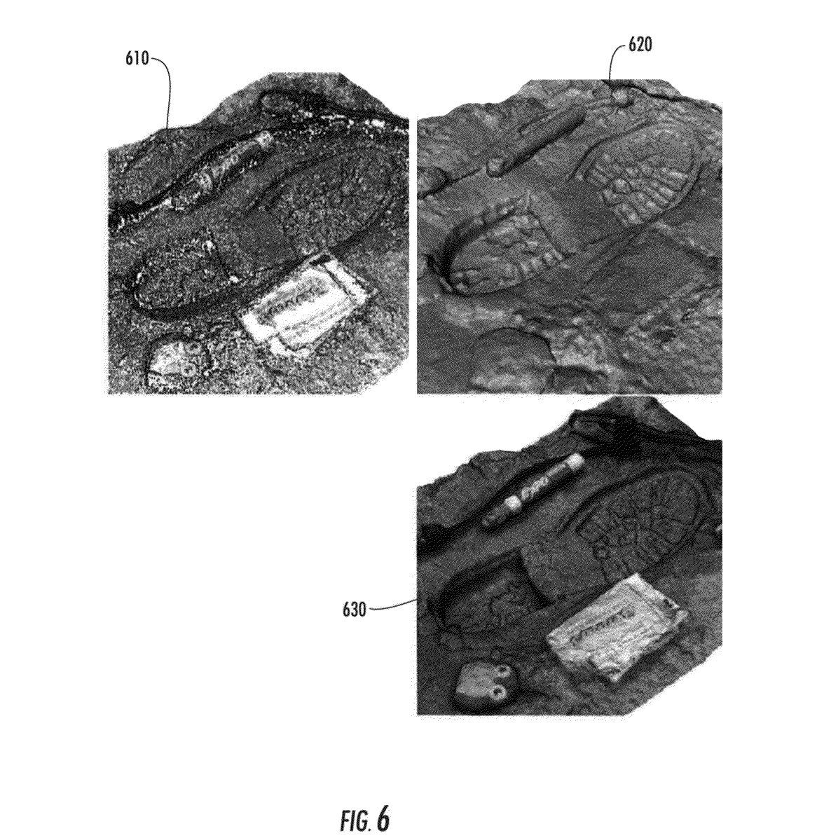

In a preferred embodiment a colored watertight surface is reconstructed from a set of colored oriented points. A colored oriented point is an oriented point with an additional point color. FIG. 6 shows a colored oriented point cloud 610, a surface 620 reconstructed using only the point locations and point orientation vectors, and a colored surface 630 reconstructed using the point locations, the point orientation vectors, and the point colors. The method to reconstruct the colored watertight surface from the set of colored oriented points comprises three steps: a first step of reconstructing a watertight surface from the point locations and point orientation vector; a second step of minimizing a color energy functional

$${E}_{C} ( g ) = {μ}_{0} {\sum }_{i = 1}^{N} {‖ g ( {p}_{i} ) - {c}_{i} ‖}^{2} + {μ}_{1} {\int }_{V} {‖ ∇ g ( x ) ‖}^{2} d x$$

comprising a weighted sum of a first color data term

$${\sum }_{i = 1}^{N} {‖ g ( {p}_{i} ) - {c}_{i} ‖}^{2}$$

and a second color regularization term ∫_{V}∥∇g(x)∥²dx, resulting in a volumetric color map g(x) defined on the signed distance function domain, with values in a color space, and where the parameters μ₀, and μ₁ are positive numbers also provided to the method as input along with the set of colored oriented points; and a third step of constructing a surface color map defined on the watertight surface by restricting the volumetric color map to the watertight surface. In a preferred embodiment the color space is an RGB space.

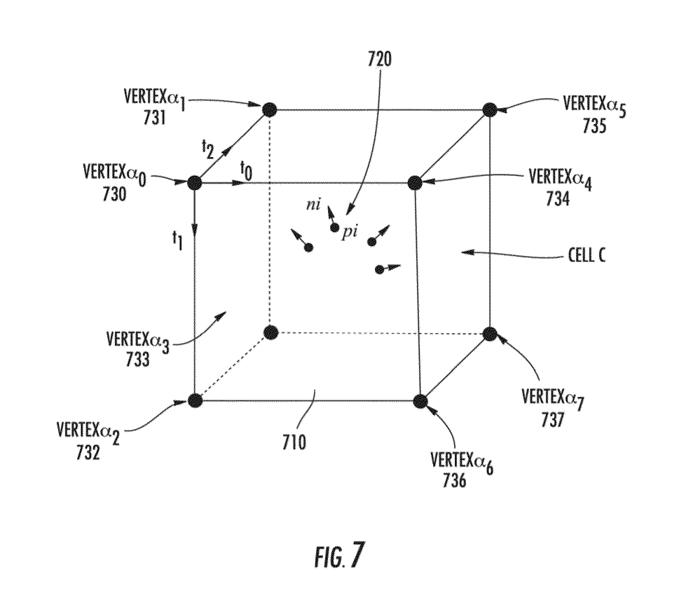

In a preferred embodiment the signed distance domain is partitioned into a volumetric hexahedral mesh. A volumetric hexahedral mesh comprises a plurality of grid vertices, a plurality of grid edges, a plurality of grid faces, and a plurality of grid cells, each grid edge of the plurality of grid edges being a pair of grid vertices, each grid face of the plurality of grid faces being a quadrilateral, each grid cell of the plurality of grid cells being an hexahedral cell, each grid vertex of the plurality of grid vertices having an associated common index α belonging to a set of three dimensional integer multi-indices Λ, an associated grid vertex location x_{α}, and an associated common parameter η_{α}. FIG. 7 shows an hexahedral cell 710 containing some of the oriented points 720 and having eight grid vertices 730,731,732,733,734,735,736, and 737. In a more preferred embodiment, each function basis function ƒ_{α}(x) attains the value 1 at the corresponding grid vertex location ƒ_{α}(x_{α})=1, attains the value 0 at any other grid vertex location ƒ_{α}(x_{β})=0, and attains values strictly between 0 and 1 at any other point within the signed distance domain. As a result, in this embodiment each common parameter η_{α} is equal to the value attained by the signed distance function at the corresponding grid vertex location

$$f ( {x}_{β} ) = {\sum }_{α ∈ Λ} {η}_{α} {f}_{α} ( {x}_{β} ) = {η}_{β} {f}_{β} ( {x}_{β} ) = {η}_{β} .$$

Each grid cell C of the volumetric hexahedral mesh has eight corners with common indices α₀, α₁, α₂, α₃, α₄, α₅, α₆, and α₇. Within the cell C the signed distance function ƒ(x) is discretized by trilinear interpolation

$$f ( x ) = {\sum }_{h = 0}^{7} {η}_{{α}_{k}} {w}_{h} ( x )$$

where w₀(x), . . . , w₇(x) are the trilinear coordinates of the point location x internal to the cell C. The gradient ∇ƒ(x) is discretized as a piecewise constant function with values determined as finite differences according to the following expression

$${∇}_{C} f = \frac{1}{4 {d}_{α}} ( \begin{matrix}{η}_{{α}_{4}} - {η}_{{α}_{0}} + {η}_{{α}_{5}} - {η}_{{α}_{1}} + {η}_{{α}_{6}} - {η}_{{α}_{2}} + {η}_{{α}_{7}} - {η}_{{α}_{3}} \\ {η}_{{α}_{2}} - {η}_{{α}_{0}} + {η}_{{α}_{3 }} - {η}_{{α}_{1}} + {η}_{{α}_{6}} - {η}_{{α}_{4}} + {η}_{{α}_{7}} - {η}_{{α}_{5 }} \\ {η}_{{α}_{1}} - {η}_{{α}_{0}} + {η}_{{α}_{3}} - {η}_{{α}_{2 }} + {η}_{{α}_{5}} - {η}_{{α}_{4}} + {η}_{{α}_{7}} - {η}_{{α}_{6}}\end{matrix} ) .$$

The piecewise constant gradient has derivatives equal to zero within the cell. The Hessian Hƒ(x) is a generalized function supported on the grid faces shared by neighboring grid cells. If C₁ and C₂ are two such grid cells that share a portion of a grid face F₁₂, the average value of the Hessian Hƒ(x) over the shared portion of the grid face is

$${H}_{{C}_{1} {C}_{2}} f = \frac{1}{{d}_{{C}_{1} {C}_{2 }}} ( {∇}_{{C}_{1}} f - {∇}_{{C}_{2}} f )$$

where d_{C}_{₁}_{C}_{₂} is the Euclidean distance between the centers of the cells, and the regularization term reduces to a sum over all the grid faces

$${\int }_{D} {‖ Hf ( x ) ‖}^{2} d x = \frac{1}{\vert D \vert} {\sum }_{( {C}_{1} {C}_{2} )} {\vert D \vert}_{{C}_{1} {C}_{2}} {‖ {H}_{{C}_{1} {C}_{2}} f ‖}^{2}$$

where |D|_{C}_{₁}_{C}_{₂} is the area of the grid face shared by the grid cells C₁ and C₂, and |D| is the sum of all the grid faces

$$\vert D \vert = {\sum }_{( {C}_{1} {C}_{2} )} {\vert D \vert}_{{C}_{1} {C}_{2}}$$

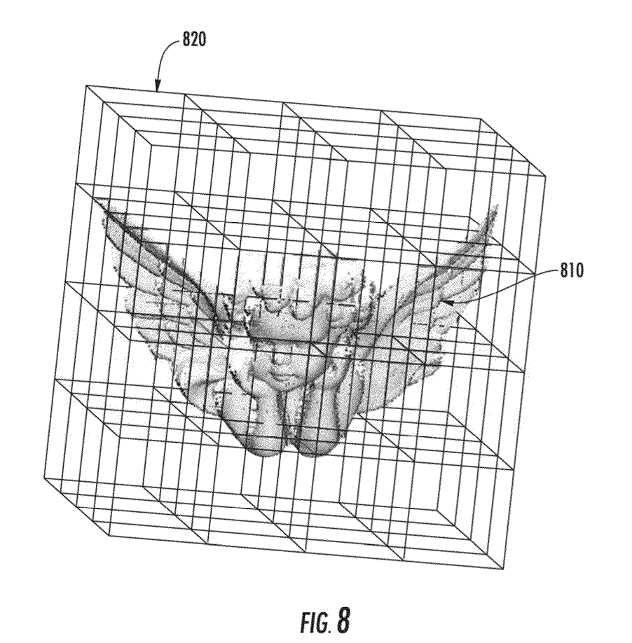

In a preferred embodiment the volumetric hexahedral mesh is a voxel grid, the vertex indices are multi-indices α=(i, j, k). FIG. 8 shows an oriented point cloud 810 contained within a smooth signed distance domain partitioned into a voxel grid 820. The set indices Λ is a set of three dimensional integer multi-indices which span a range of values 0≦i, j, k≦M and the coordinates of the grid vertex locations are normalized to the range between 0 and 1 x_{α}=(i/M, j/M, k/M). The grid cells C_{α} are also indexed by multi-indices α=(i, j, k), except that in this case 0≦i, j, k<M. The eight multi-indices of the vertices of this this cell are α₀=(i, j, k), α₁=(i, j, k+1), α₂=(i, j+1, k), α₃=(i, j+1, k+1), α₄=(i+1, j, k), α₅=(i+1, j, k+1), α₆=(i+1, j+1, k), and α₇=(i+1, j+1, k+1). Determining which cell C contains each point location pᵢ reduces to quantization. Since the common parameters constitute a scalar field defined on the vertices of voxel grid, a polygon mesh approximation of the surface can be computed using one of the isosurface algorithms for regular voxel grids known in the prior art such as Marching Cubes, which does not require any further signed distance function evaluations.

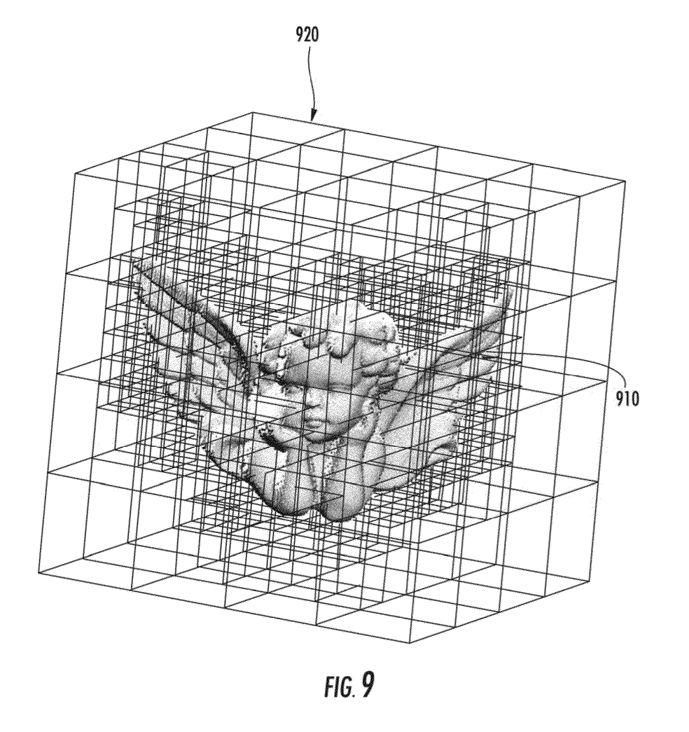

In another preferred embodiment the volumetric hexahedral mesh is an octree and the polygon mesh approximation of the surface is computed using one of the octree isosurface algorithms known in the prior art. FIG. 9 shows an oriented point cloud 910 contained within a smooth signed distance domain partitioned into a voxel grid 920. In a more preferred embodiment the octree is contructed by recursively subdividing the signed distance function domain as a function of the point locations. In another more preferred embodiment the octree is contructed by recursively subdividing the signed distance function domain as a function of the point locations and point orientation vectors. In another more preferred embodiment the octree isosurface algorithm is the Dual Marching Cubes algorithm.

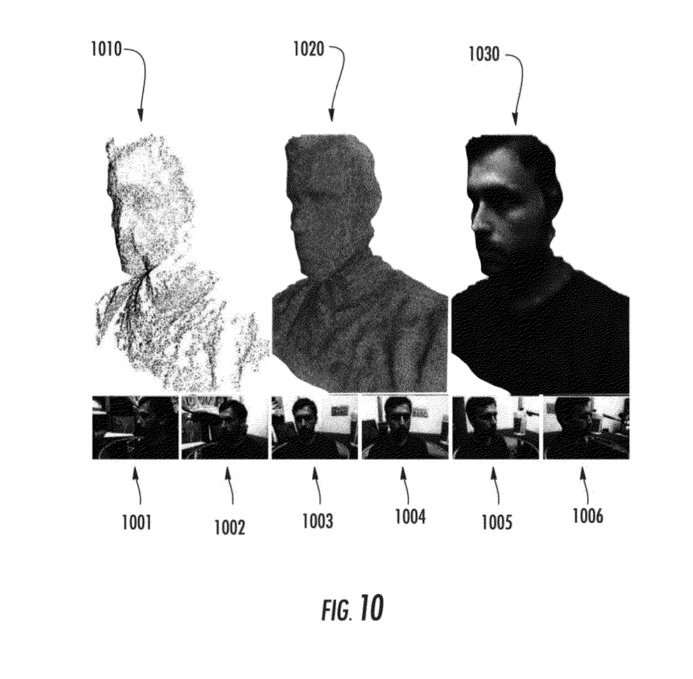

In another preferred embodiment the watertight surface is reconstructed from a set of photographs of a 3D object. The method to reconstruct a watertight surface from a set of photographs of a 3D object comprises the following steps: a first step of photographing the object from different points of view with a high resolution digital camera; a second step of obtaining the so called “camera calibration” parameters, comprising intrinsic parameters associated with the camera optics, and extrinsic parameters describing the camera pose in 3D. In a preferred embodiment the relative position and orientation of the camera corresponding to each photo is recovered by extracting feature points from the photos, matching them up, and then running a structure from motion (SfM) algorithm, followed by a bundle adjustment refinement step. In another preferred embodiment a capture system with multiple cameras mounted in static positions with respect to the object is used to capture the photographs. In this case, a standard camera calibration procedure can be followed to estimate the camera positions, orientations, and intrinsic parameters before the photographs of the object are captured. After the cameras are calibrated, multiple objects of similar dimensions can be photographed with the same setup. There is no need to recompute the camera calibration data unless the cameras are moved or the optics are modified. When using a single handheld camera, it is critical to obtain good results by preventing shaking the camera while taking the photographs or making changes in the optics. Best results are obtained with a camera with good image stabilization software, and setting it in manual mode, so that focus, zoom, aperture, and other parameters are constant across the capture session. Some cameras produce better results than others, despite having the same number of pixels, and similar characteristics. A third step of generating a dense colored point cloud with surface normal vectors using a multi view stereo algorithm using methods disclosed in the art for such a process. And a fourth step of reconstructing a colored watertight surface from the colored oriented point cloud. FIG. 10 shows a colored point cloud 1010 obtained from a set of photographs 1001, 1002, 1003, 1004, 1005, and 1006, using a multi-view stereo algorithm, the surface 1020 reconstructed from the oriented points, and the colored surface 1030 reconstructed from the colored oriented points used an application to view interpolation for face to face teleconferencing.

The system of the present invention for reconstructing colored 3D models from multiple photographs captured by inexpensive consumer level digital cameras has a wide range of applications in industry, entertainment, human computer interaction, surveillance, navigation, archaeology, forensics, medicine, sports, architecture, and many other fields.

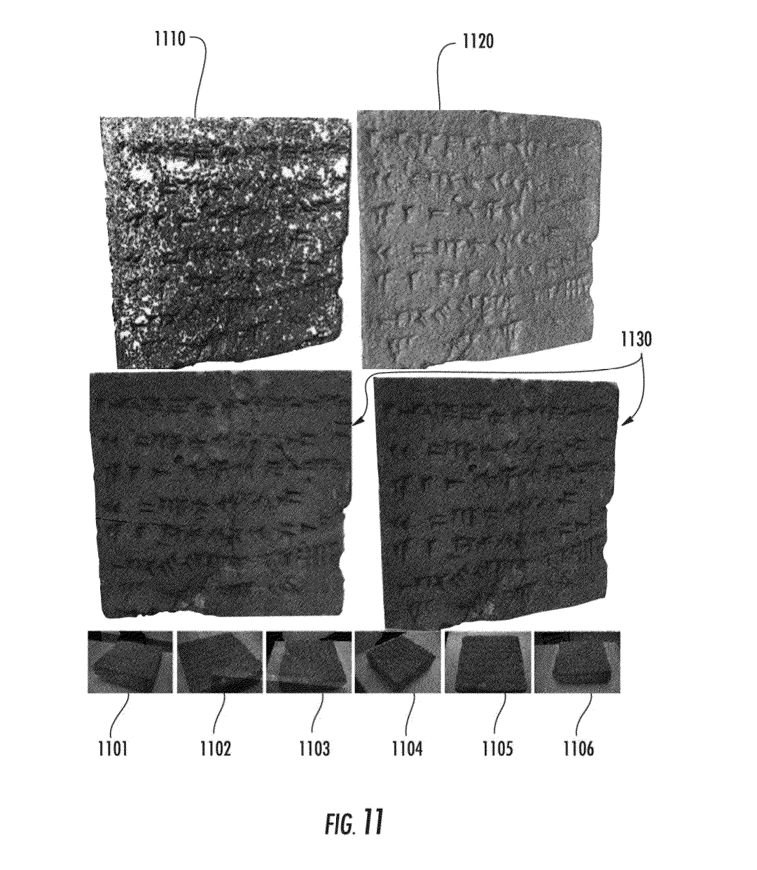

FIG. 11 shows an application of the present invention to a problem of interest such as the reconstruction of cuneiform tablet surfaces where we can see a colored point cloud 1110 obtained from a set of photographs, the surface 1120 reconstructed from the oriented points, and the colored surface 1130 reconstructed from the colored oriented points shown rendered from two points of view. The cuneiform characters must be segmented out of the surface from which they have been carved for further analysis and interpretation. We use a curvature based approach to determine the boundaries of the strokes. In differential geometry, curvature of a 3D surface along a certain tangent direction is defined as the directional derivative of the normal vector field along the given tangent direction. The collection of all these directional curvature values constitutes the so called tensor of curvature. Efficient algorithms exist to estimate the tensor of curvature of a surface approximated by a polygon mesh. Directional curvature can also be evaluated across a mesh edge by finite differences from the face normal corresponding to the two faces incident to the given edge. Since each cuneiform stroke is bounded by a high curvature curve, which in a polygon mesh is approximated by a sequence of mesh edges, we will partition the polygon faces into connected components, with two faces sharing an edge joined into the same component if the curvature across the common edge is below a certain threshold. By choosing the proper threshold we segment out the polygon faces that correspond to strokes, and segment them out of the polygon mesh.

To estimate the original surface of the object, before the cuneiform characters were carved, we use the following approach. The polygon mesh is estimated from the oriented point cloud by reconstructing a smooth signed distance function. The domain of this smooth signed distance is a hierarchical partition of a 3D volume enclosing all the points. In our implementation, we use an octree as a hierarchical partition. The octree cells containing the polygon face segmented out as a cuneiform stroke can easily be determined and used to identify the point associated with that particular stroke. We create a new point cloud by removing the points associated with strokes from the original point cloud used as input to the SSD Surface Reconstruction algorithm. The result is an unevenly sampled surface. Now we run the iterative portion of the SSD surface reconstruction algorithm again on this smaller colored oriented point cloud data set, starting with the smooth signed distance obtained from the original point cloud. Since the SSD surface reconstruction algorithm performs particularly well on unevenly sampled points, this process converges quickly to an estimate of the original surface of the object, before the cuneiform characters were carved.

The next step is to flatten this surface, so that the character recognition problem is reduced to 2D from 3D, but rather than using splines, we use mesh based parameterization techniques. The goal is to lay down the strokes on a flat surface, while preserving the local relative positions, orientations, and sizes. Then a simple mathematical model that describes a cuneiform stroke using a few parameters, is used to describe the configuration of strokes on the flattened surface. Then we use standard geometry based and statistical based pattern recognition techniques and variations of optical character recognition techniques to perform preliminary classification of individual characters and to group them into words.

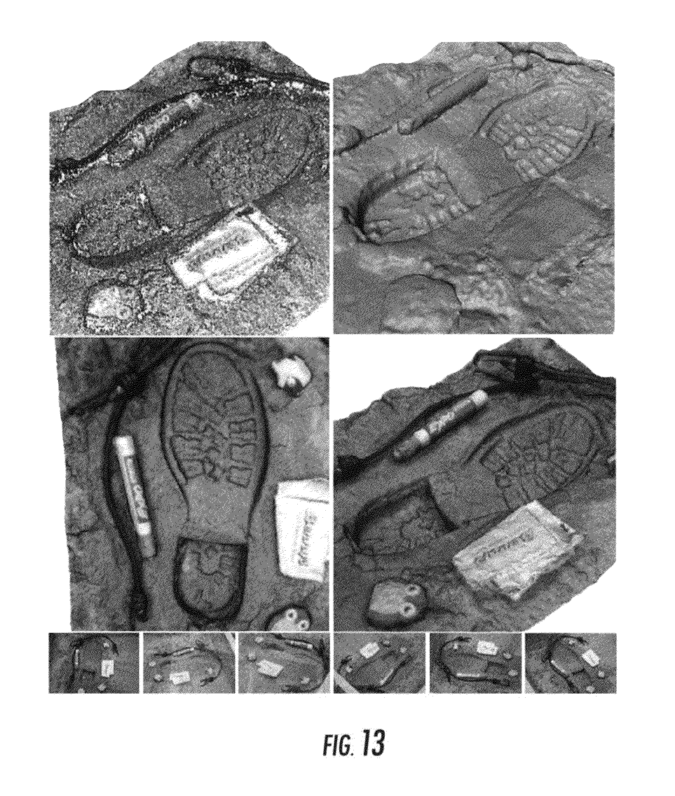

Still further FIG. 13 shows an application to forensic 3D reconstruction of shoeprints, where this method has been proven to be competitive in terms of accuracy with laser scanners, at a much lower cost. An efficient crime investigation depends on the collection and analysis of various kinds of evidence gathered at the crime scene, such as DNA, tire tracks, fingerprints, shoe prints, bloodstains, among others. Since dense oriented point clouds do not constitute surfaces, they cannot be used to make certain measurements required by many applications in forensics. Impression evidence, such as footprints, tire tracks, and tool marks, are an important and common source of physical evidence that can be used to corroborate or refute information provided by witnesses or suspects. Shoe prints can indicate whether a person was walking or running, was carrying something heavy or was unfamiliar with the area or unsure of the terrain. They can provide additional information about the wearer, such as weight, height, and wear patterns that can be compared with a suspect's shoes. The location of the impressions at the scene can also often help in the reconstruction of the crime.

Shoe prints can be classified in three categories, based on how they are found at the crime scene: patent, plastic, or latent. Patent shoe prints are those that are clearly visible at the crime scene; plastic or three-dimensional (3D) prints occur when the shoe sinks in the material that is being stepped on, leaving marks; and latent prints are invisible to the naked eye and need to be exposed using different forensic techniques. Plastic or 3D footwear impressions have depth in addition to length and width, and are most commonly found outdoors in soil, sand, and snow. The details that can be retained and captured depend on the material texture, composition, and conditions and these attributes can largely vary.

In recent years, the standard method for capturing these 3D prints is by casting using materials such as dental stone or plaster, and photographing the print to provide additional details which are taken into consideration later. The produced cast can be compared with manufactures' shoes or analyzed in search of minutiae that can provide information about the wearer.

Just as shoe prints, each type of evidence requires a different forensic technique to be revealed, captured and analyzed. These techniques have been improving over the last years due to reliability of modern technology and the greater use of computational forensics. For example, pattern recognition and other computational methods can reduce the bias inherent in traditional criminal forensics. In this sense, an ever growing system to collect evidence is 3D scanning. It is useful not only in collecting, but also in organizing evidence and providing an analysis tool.

Accordingly it can be seen that the present invention provides a method for reconstructing watertight surfaces defined by implicit equations from finite sets of oriented points. Sets of oriented point clouds are obtained using other methods known and described in the art such as from laser scanners, structured lighting systems, and multiview stereo algorithms. For these reasons, the instant invention is believed to represent a significant advancement in the art, which has substantial commercial merit.

Although the invention is described for the reconstruction of surfaces from oriented points in 3D, the method applies to any other space dimension. For example, in 2D the method reconstructs a 2D curve from a set of 2D oriented points. Those skilled in the art

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for estimating a signed distance function from a plurality of oriented 3-D points, each of said plurality of oriented 3-D points comprising a point location and a point orientation vector, the method comprising:
minimizing a signed distance energy function, the signed distance energy function comprising:
a first data term being a sum of a plurality of point location error terms relating to each of said oriented 3-D point locations,
a second data term being a sum of a plurality of point orientation vector error terms relating to each of said oriented 3-D point orientation vectors, and
a third regularization term being a non-negative norm of the second derivatives of a signed distance function over a signed distance function domain, wherein the signed distance energy function domain contains the plurality of oriented 3-D points.

2. The method of claim 1, wherein:
each of the plurality of point location error terms is a square of the value attained by the signed distance function evaluated at each of the point locations of the plurality of oriented 3-D points;
each of the plurality of point orientation vector error terms is a square of the Euclidean norm of the difference between the orientation vector of each of the plurality of oriented 3-D points and a value attained by a gradient of the signed distance function evaluated at each of the point locations of the plurality of oriented 3-D points; and
the non-negative norm of the signed distance function over the signed distance function domain is an integral over the signed distance function domain of a value of the square of a Frobenius norm of a Hessian of the signed distance function.

3. The method of claim 2, wherein:
the signed distance function is a first linear combination of a plurality of basis functions;
the gradient of the signed distance is a second linear combination of a plurality of gradient basis functions,
the Hessian of the signed distance is a third linear combination of a plurality of Hessian basis functions;
the first, second and third linear combinations comprising the same number of basis functions;
the same linear combination coefficients are shared by the first, second, and third linear combinations; and
the estimating reduces to solving a least squares problem where said linear combination coefficients are the unknowns.

4. The method of claim 3, wherein:
each of the plurality of basis functions has continuous second order derivatives defined on the signed distance function domain;
each of the plurality of the gradient basis functions is the gradient of one of the plurality of basis functions; and
each of the plurality of the Hessian basis functions is the Hessian of one of the plurality of basis functions.

5. The method of claim 3, where the plurality of basis functions is subordinated to a partition of the signed distance function domain.

6. The method of claim 5, where the partition is a regular voxel grid.

7. The method of claim 5, where the partition is an octreee.

8. The method of claim 5, where the partition is a dual octree.

9. A method for reconstructing a surface from a plurality of oriented 3-D points comprising:
estimating a signed distance from the plurality of oriented 3-D points; and
reconstructing a surface as a level set of the signed distance function.

10. The method of claim 9, where the level set of the signed distance function is approximated by a polygon mesh.
